(19) United States
(12) Patent Application Publication
(10) Pub. No.: US 2023/0404070 A1
(43) Pub. Date: Dec. 21, 2023

(54) SEED COATING COMPOSITIONS

(71) Applicant: Dow Global Technologies LLC, Midland, MI (US)

(72) Inventors: Yongchun Chen, Shanghai (CN); Zeyu Zhong, Shanghai (CN); Ling Zhong, Shanghai (CN); Jing Ji, Shanghai (CN); Chen Zheng, Shanghai (CN); Sensen Shen, Shanghai (CN)

(21) Appl. No.: 18/251,786

(22) PCT Filed: Jan. 21, 2021
(86) PCT No.: PCT/CN2021/073092

§ 371 Date: May 4, 2023

(51) Int. Cl. A01N 25/04; A01C 1/06; A01N 31/02

(52) U.S. Cl. CPC A01N 25/04; A01C 1/06; A01N 31/02

(57) ABSTRACT

A seed coating composition includes a silane-functionalized polymer. The silane-functionalized polymer is acrylate-based. The seed coating composition also includes polydimethylsiloxane having a weight average molecular weight of 500,000 g/mol or greater as measured according to Gel Permeation Chromatography.

### BACKGROUND

### Field of the Disclosure

The present disclosure relates to compositions, and more specifically to seed coating compositions.

### INTRODUCTION

Seeds used for growing crops often include one or more coatings disposed on an exterior surface of the seed. The coatings may serve to adhere agriculturally active components (e.g., fertilizers, pesticides, antibacterial agent, plant growth regulator) to the surface of the seed and/or impart a variety of beneficial properties (e.g., protection of seeds from bacteria/insect/injury, promoting plant growth, gas or water permeability etc.). During manufacturing, transportation and planting of the seed, the coating is exposed to a variety of conditions such as mechanical forces and moisture that may negatively affect the integrity of the coating and/or its adherence to the seed. The coating's resistance to flaking and chipping due to mechanical forces is quantified as its “attrition rate” with smaller values representing less loss of the coating. Generally, an attrition rate of greater than 8% is considered failing. The coating must also resist dissolution when exposed to water as well as have a low coefficient of friction surface such that the coated seeds do not clump and bind to one another during handling.

Various attempts at improving properties of the coating have been attempted. For example, U.S. Pat. No. 5,106,649 (“the '649 patent”) discloses the use of polydimethylsiloxane (“PDMS”) lubricant in conjunction with polyethylene glycol, alkyd resin or polyacrylate-based coating to improve the bulk flow properties of pesticide treated seeds. Specifically, the '649 patent utilizes PDMS having a molecular weight of from 10,000 grams per mol (“g/mol”) to 400,000 g/mol and more preferably from 50,000 g/mol to 200,000 g/mol.

Improving adhesion between seed coatings and the seed has been attempted primarily through coating functionalization using monomers such as maleic anhydride. The use of silane-functionalization to increase adhesion between a polymer and an inorganic surface is well known and so is the silane-functionalization of acrylate polymers. For example, United States Patent Publication number 2004/0259991 A1 discloses a self-stable silane modified (meth)acrylic latex interpolymer composition. However, due to regulations implemented by the United States Environmental Protection Agency (“EPA”) and adopted in other jurisdictions, silane-functionalized polymers have not been used in connection with agricultural seeds. As such, the efficacy of silane-functionalization for seed coatings is unknown.

Competing with the coating properties listed above is the requirement that the coating not inhibit germination of the seed. For example, the coating must be moisture and gas permeable in order for the seed to begin germination. Further, the coating's adhesion to the seed and/or the rigidity of the coating should not impede the opening of the seed and emergence of the new plant. Generally, seed coatings that result in less than 85% seed germination are considered a failure.

In view of the foregoing, it would be surprising to discover a seed coating composition that has an attrition rate less than 8%, meets water resistance and flowability properties while achieving an 85% germination rate or better.

### SUMMARY OF THE DISCLOSURE

The present invention provides a seed coating composition that has an attrition rate less than 8%, meets water resistance and flowability properties while achieving an 85% seed germination rate or better.

The present invention is a result of discovering that by utilizing a silane-functionalized polymer in conjunction with polydimethylsiloxane having a weight average molecular weight of 500,000 g/mol or greater allows for the formation of a seed coating composition that can meet the above-noted properties. Without being bound by theory, it is believed that the silane-functionalization of the polymer is able to effectively bind to the exterior surface of the seed while the polydimethylsiloxane is able to reduce the coefficient of friction of the coating. It has been surprisingly discovered that despite the increased adhesion offered by the use of the silane-functionalized polymer, the seed coating composition does not unduly inhibit germination and 85% or greater of the seeds are able to germinate. Further, it is surprising that the incorporation of the polydimethylsiloxane having a weight average molecular weight of 500,000 g/mol or greater does not thicken the coating to the point that germination is decreased below 85%.

The present invention is particularly useful for use in protecting seeds.

According to a first feature of the present disclosure, a seed coating composition comprises a silane-functionalized polymer, wherein the silane-functionalized polymer is acrylate-base, and polydimethylsiloxane having a weight average molecular weight of 500,000 g/mol or greater as measured according to Gel Permeation Chromatography.

According to a second feature of the present disclosure, the silane-functionalized polymer comprises units derived from a silane monomer selected from the group consisting of vinyltrimethoxysilane, methacryloxy propyl trimethoxyl silane and combinations thereof.

According to a third feature of the present disclosure, the silane-functionalized polymer comprises units derived from butyl acrylate, methyl methacrylate, glacial methacrylic acid and styrene.

According to a fourth feature of the present disclosure, the polydimethylsiloxane has a weight average molecular weight of 500,000 g/mol to 2,500,000 g/mol as measured according to Gel Permeation Chromatography.

According to a fifth feature of the present disclosure, the silane-functionalized polymer has a glass transition temperature of 0° C. to 40° C. as measured according to ASTM D7028.

According to a sixth feature of the present disclosure, a weight ratio of the silane-functionalized polymer to the polydimethylsiloxane within the seed coating composition is from 99:1 to 75:25.

According to a seventh feature of the present disclosure, the weight ratio of the silane-functionalized polymer to the polydimethylsiloxane within the seed coating composition is from 96:4 to 85:15.

According to an eighth feature of the present disclosure, the seed coating composition further comprises water, wherein the silane-functionalized polymer, the polydimethylsiloxane and the water form an emulsion.

According to a ninth feature of the present disclosure, a coated seed, comprises a seed defining an exterior surface and the seed coating composition in contact with the exterior surface of the seed.

According to a tenth feature of the present disclosure, a method of forming a coated seed comprises the steps of forming a silane-functionalized polymer that is acrylate-based; combining a polydimethylsiloxane having a weight average molecular weight of 500,000 g/mol or greater as measured to Gel Permeation Chromatography with the silane-functionalized polymer to form a seed coating composition; and applying the seed coating composition to a seed to form a coated seed.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut für Normung; and ISO refers to International Organization for Standards.

As used herein, the term weight percent (“wt %”) designates the percentage by weight a component is of a total weight of the polymeric composition unless otherwise indicated.

As used herein, a “CAS number” is the chemical services registry number assigned by the Chemical Abstracts Service.

### Seed Coating Composition

The present disclosure is directed to a seed coating composition. The seed coating composition comprises a silane-functionalized polymer and polydimethylsiloxane. The seed coating composition may exist as an aqueous emulsion or as a coating on a seed. In the aqueous emulsion form of the seed coating composition, the silane-functionalized polymer and the polydimethylsiloxane are emulsified in water. As explained in greater detail below, the aqueous emulsion of the seed coating composition is applied to a seed to form a coated seed. The coated seed exists as the seed with the seed coating composition dried and adhered to an external surface of the seed.

### Silane Functionalized Polymer

The seed coating composition comprises the silane-functionalized polymer. A “silane-functionalized polymer” is a polymer that contains silane. The silane-functionalized polymer is “acrylate-based” meaning that the silane-functionalized polymer comprises equal to or greater than 50 wt %, or a majority amount, of polymerized units selected from the group consisting of methyl methacrylate, methacrylate, styrene, butyl methacrylate, acrylic acid, methacrylic acid, glacial methacrylic acid and 2-ethylhexyl acrylate and trimethylolpropane triacrylate based on the total weight of the silane-functionalized polymer. As used herein, the term “unit” of the named monomer refers to the remnant of the monomer after polymerization. The silane-functionalized polymer may include a copolymer of silane and the monomers, a silane-grafted polymer, and/or combinations thereof. Copolymer examples of the silane-functionalized polymer are formed from the copolymerization of the acrylate monomers and a silane monomer (such as a vinyl silane monomer) such that the silane monomer is incorporated into the backbone of the polymer. In grafted examples of the silane-functionalized polymer, a silane monomer is grafted onto the backbone of a polymer such that the monomer or its derivate is pendant off of the backbone.

A “silane monomer” is a silane-containing monomer that will effectively copolymerize with one of the above-noted monomers form a monomer/silane copolymer, or graft to the backbone of a polymer formed from the monomers. A representative, but not limiting, example of a silane monomer has structure (I):

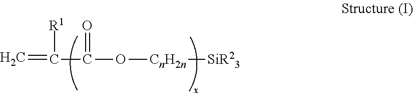

in which R¹ is a hydrogen atom or methyl group; x is 0 or 1; n is an integer from 1 to 4, or 6, or 8, or 10, or 12; and each R² independently is an organic group such as an alkoxy group having from 1 to 12 carbon atoms (e.g., methoxy, ethoxy, butoxy), an aryloxy group (e.g., phenoxy), an araloxy group (e.g., benzyloxy), an aliphatic acyloxy group having from 1 to 12 carbon atoms (e.g., formyloxy, acetyloxy, propanoyloxy), an amino or substituted amino group (e.g., alkylamino, arylamino), or a lower-alkyl group having 1 to 6 carbon atoms, with the proviso that not more than one of the three R² groups is an alkyl.

The silane monomer may include silane monomers that comprise an ethylenically unsaturated hydrocarbyl group, such as a vinyl, allyl, isopropenyl, butenyl, cyclohexenyl or gamma (meth)acryloxy allyl group, and a hydrolyzable group, such as, for example, a hydrocarbyloxy, hydrocarbonyloxy, or hydrocarbylamino group. Hydrolyzable groups may include methoxy, ethoxy, formyloxy, acetoxy, proprionyloxy, and alkyl or arylamino groups. Examples of silane monomers include vinyltrimethoxysilane (VTMS), vinyltriethoxysilane (VTES), vinyltriacetoxysilane, and gamma-(meth)acryloxy propyl trimethoxy silane. In context to Structure (I), for VTMS: x=0; R¹=hydrogen; and R²=methoxy; for VTES: x=0; R¹=hydrogen; and R²=ethoxy; and for vinyltriacetoxysilane: x=0; R¹=H; and R²=acetoxy. The silane monomer may also include methacryloxy propyl trimethoxyl silane.

The silane-functionalized polymer has a glass transition temperature of 0° C. to 40° C. as measured according to ASTM D7028. For example, the glass transition temperature of the silane-functionalized polymer is 0° C. or greater, or 5° C. or greater, or 10° C. or greater, or 15° C. or greater, or 20° C. or greater, or 25° C. or greater, or 30° C. or greater, or 35° C. or greater, while at the same time, 40° C. or less, or 35° C. or less, 30° C. or less, or 25° C. or less, or 20° C. or less, or 15° C. or less, or 10° C. or less, or 5° C. or less as measured ASTM D7028.

The seed coating composition may comprise from 1 wt % to 30 wt % of the silane-functionalized polymer based on the total weight of the seed coating composition. For example, the seed coating composition may comprise 1 wt % or greater, or 2 wt % or greater, or 4 wt % or greater, or 6 wt % or greater, or 8 wt % or greater, or 10 wt % or greater, or 12 wt % or greater, or 14 wt % or greater, or 16 wt % or greater, or 18 wt % or greater, or 20 wt % or greater, or 22 wt % or greater, or 24 wt % or greater, or 26 wt % or greater, or 28 wt % or greater, while at the same time, 30 wt % or less, or 28 wt % or less, or 26 wt % or less, or 24 wt % or less, or 22 wt % or less, or 20 wt % or less, or 18 wt % or less, or 16 wt % or less, or 14 wt % or less, or 12 wt % or less, or 10 wt % or less, or 8 wt % or less, or 6 wt % or less, or 4 wt % or less, or 2 wt % or less of the silane-functionalized polymer based on a total weight of the seed coating composition.

### Polydimethylsiloxane

The seed coating composition comprises polydimethylsiloxane. The PDMS has a CAS number of 9016-00-6. The PDMS has a weight average molecular weight of 500,000 g/mol or greater, or 600,000 g/mol or greater, or 700,000 g/mol or greater, or 800,000 g/mol or greater, or 900,000 g/mol or greater, or 1,000,000 g/mol or greater, or 1,100,000 g/mol or greater, or 1,200,000 g/mol or greater, or 1,300,000 g/mol or greater, or 1,400,000 g/mol or greater, or 1,500,000 g/mol or greater, or 1,600,000 g/mol or greater, or 1,700,000 g/mol or greater, or 1,800,000 g/mol or greater, or 1,900,000 g/mol or greater, or 2,000,000 g/mol or greater, or 2,100,000 g/mol or greater, or 2,200,000 g/mol or greater, or 2,300,000 g/mol or greater, or 2,400,000 g/mol or greater, while at the same time, 2,500,000 g/mol or less, or 2,400,000 g/mol or less, or 2,300,000 g/mol or less, or 2,200,000 g/mol or less, or 2,100,000 g/mol or less, or 2,000,000 g/mol or less, or 1,900,000 g/mol or less, or 1,800,000 g/mol or less, or 1,700,000 g/mol or less, or 1,600,000 g/mol or less, or 1,500,000 g/mol or less, or 1,400,000 g/mol or less, or 1,300,000 g/mol or less, or 1,200,000 g/mol or less, or 1,100,000 g/mol or less, or 1,000,000 g/mol or less, or 900,000 g/mol or less, or 800,000 g/mol or less, or 700,000 g/mol or less, or 600,000 g/mol or less as measured according to Gel Permeation Chromatography as explained below.

The seed coating composition may comprise from 0.1 wt % to 6 wt % of the PDMS based on the total weight of the seed coating composition. For example, the seed coating composition may comprise 0.1 wt % or greater, or 0.2 wt % or greater, or 0.4 wt % or greater, or 0.6 wt % or greater, or 0.8 wt % or greater, or 1.0 wt % or greater, or 1.2 wt % or greater, or 1.4 wt % or greater, or 1.6 wt % or greater, or 1.8 wt % or greater, or 2.0 wt % or greater, or 2.2 wt % or greater, or 2.4 wt % or greater, or 2.6 wt % or greater, or 2.8 wt % or greater, or 3.0 wt % or greater, or 3.2 wt % or greater, or 3.4 wt % or greater, or 3.6 wt % or greater, or 3.8 wt % or greater, or 4.0 wt % or greater, or 4.2 wt % or greater, or 4.4 wt % or greater, or 4.6 wt % or greater, or 4.8 wt % or greater, or 5.0 wt % or greater, or 5.2 wt % or greater, or 5.4 wt % or greater, or 5.6 wt % or greater, or 5.8 wt % or greater, while at the same time, 6.0 wt % or less, or 5.8 wt % or less, or 5.6 wt % or less, or 5.4 wt % or less, or 5.2 wt % or less, or 5.0 wt % or less, or 4.8 wt % or less, or 4.6 wt % or less, or 4.4 wt % or less, or 4.2 wt % or less, or 4.0 wt % or less, or 3.8 wt % or less, or 3.6 wt % or less, or 3.4 wt % or less, or 3.2 wt % or less, or 3.0 wt % or less, or 2.8 wt % or less, or 2.6 wt % or less, or 2.4 wt % or less, or 2.2 wt % or less, or 2.0 wt % or less, or 1.8 wt % or less, or 1.6 wt % or less, or 1.4 wt % or less, or 1.2 wt % or less, or 1.0 wt % or less, or 0.8 wt % or less, or 0.6 wt % or less, or 0.4 wt % or less, or 0.2 wt % or less of the PDMS based on a total weight of the seed coating composition.

A weight ratio between the silane-functionalized polymer and the PDMS within the seed coating composition is from 99:1 to 75:25. For example, the weight ratio between the silane-functionalized polymer and the PDMS may be 99:1, or 96:4, or 95:5, or 90:10, or 85:15, or 80:20, while at the same time, 75:25, or 80:20, or 85:15, or 90:10, or 95:5, or 96:4. In aqueous emulsion examples, the weight ratio between the silane-functionalized polymer and the PDMS is measured based on the solids of the emulsions and does not include solvent or water weight.

### Additives

The seed coating composition may comprise one or more additives in addition to the silane-functionalized polymer and the PDMS. For example, the seed coating composition may comprise an antifreezing agent, a thickener, an antifoaming agent, a pigment, an antiseptic agent, a pH modifier, a coalescent agent, a stabilizer, an active ingredient and/or combinations thereof. Exemplary antifreezing agents include a dihydric alcohol such as ethylene glycol or propylene glycol. The seed coating composition may comprise an antifreezing agent in an amount from 0.5 wt % to 30 wt % based on the total weight of the seed coating composition. Exemplary thickeners include polysaccharides such as xanthan gum, rhamsan gum, locust bean gum, carrageenan or welan gum; a synthetic polymer such as sodium polyacrylate; a semisynthetic polysaccharide such as carboxy methyl cellulose; a mineral fine powder such as aluminum magnesium silicate, smectite, bentonite, hectorite or fumed silica, or alumina sol. The seed coating composition may comprise from 1.0 wt % to 50.0 wt % of an active ingredient based on a total weight of the seed coating composition. Examples of active ingredients include pesticides (e.g., thiamethoxam, abamectin, fenobucarb, isoprocarb, chlorfluazuron, chlorpyrifos, fipronil, clothianidin, spinetoram, spinosad, dinotefuran, methoxyfenozide, ethofenprox, ethiprole, acephate, benfuracarb, monocrotophos, silafluofen, imidacloprid, etc.), fertilizers and/or combinations thereof. Exemplary coalescent agents include dipropylene glycol monobutyl ether, [(butoxymethylethoxy)methylethoxy]propan-1-ol, 2,2,4-Trimethyl-1,3-Pentanediol Monoisobutyrate; Isobutyric acid, ester with 2,2,4-timethyl-1,3-pentanediol, 2,2,4-Trimethyl-1,3-pentanediol monoisobutyrate, other coalescing agents and/or combinations thereof.

### Coated Seed

The seed coating composition in the aqueous emulsion state is applied to an exterior surface of a seed to form a coated seed. The exterior of the seed may be a pericarp, seed coat, endosperm or other surface to which the seed coating composition is adhered to. The seed coating composition may be applied to a variety of types of seeds. For example, the seed may be a cereal (e.g., wheat, oats, rice, corn (maize), barley, sorghum, rye, millet), a fruit, a vegetable, a legume or other types of seeds.

### Method of Making

The seed coating composition, in aqueous emulsion form, is applied to a seed in order to form a coated seed. Forming the coated seed may first start with a step of forming a silane-functionalized polymer. The silane-functionalized polymer may be an emulsion, in a latex, disposed in a carrier solvent/fluid and/or may be a dry powder. Formation of the silane-functionalized polymer may be carried out according to the description provided below on how to form the silane-functionalized polymer. Next, a step of combining polydimethylsiloxane having a weight average molecular weight of 500,000 g/mol or greater as measured according to Gel Permeation Chromatography with the silane-functionalized polymer to form a seed coating composition is performed. The PDMS may be in the form of an emulsion, in a latex, disposed in a carrier solvent/fluid and/or may be a dry powder. The additives (including an active ingredient) may be added to the seed coating composition before, during or after the combination of the PDMS and the silane-functionalized polymer. Next, a step of applying the seed coating composition to the seed is performed. The seed coating composition may be directly applied to the seeds (e.g., sprayed on) and/or the seeds may be mixed into the coating composition and then removed. After the seed coating composition has been applied to the seeds, the seed coating composition is dried to form the solid embodiment of the seed coating composition on the coated seed.

### Examples

### Test Methods

Attrition Rate: The attrition rate of the seed coating composition is determined according to the following manner. 15 g of coated corn seeds are introduced into 90 ml polyethylene plastic container. The container is fixed on KS 501 Shaker from IKA products, Staufen, Germany, and shook at a speed of 280 revolutions per minute for 15 minutes. After shaking, high performance liquid chromatography (“HPLC”) ultraviolet detection measurement is performed. The column used for the measurements is an Agilent Eclipse XDB-C18 (2.1*50 mm, 1.8 μm) column, the detector is a DAD (UV absorbance at 280 nm), the solvents used are water and acetonitrile, and the target material is thiamethoxam (THM). After the shaking, the coated corn seeds are transferred into another new 90 ml polyethylene container while the dropped coating (i.e., from the shaking) remains in the original 90 ml polyethylene container. A 40 ml mixture of the solvents (acetonitrile (ACN): H2O (0.1% H₃PO₄)=4:1) is introduced into both of the containers. Both of the two containers are first vortexed, then ultrasonically vibrated for 1 hour before shaking them overnight on the KS 501 Shaker. The samples are left for at least 30 minutes before testing. 0.5 ml supernatants from the new 90 ml container are transferred into 20-ml glass vial, and about 12 ml extraction solvent is added to dilute the samples. The samples are then shaken and have 1 ml supernatant removed and filtered by 0.22 μm polytetrafluoroethylene membrane before being analyzed by HPLC. These samples are used to calculate the remaining thiamethoxam (“m1”) on the corn seed after shaking. 1 ml solution from the original 90 ml containers are directly taken out and filtered by 0.22 μm polytetrafluoroethylene membrane before being analyzed by HPLC. These samples are used to calculate the dropped thiamethoxam (“m2”) during shaking. The attrition rate is calculated by equation 1, and each attrition rate the average of 3 repeated samples.

Attrition rate (%)=m2/(m1+m2)*100% EQ. 1

Water Resistance: Water resistance for inventive examples 1-4 and comparative examples 1-5 is determined by placing each of the examples into a petri dish with sufficient water to immerse the seeds. The examples are left for 24 hours and observed visually after 24 hours. The water resistance is classified as 3 grades (i.e., good, medium, bad). Good water resistance means there is no color in the water after immersing coated seeds in water for 24 hours with medium and bad representing incrementally more water being colored due to dissolution of the seed coting composition into the water.

Germination: The germination test is carried out according to GB/T 3543.4-1995, named Rules for agricultural seed testing—Germination Test. In the process, 200 qualified corn seeds are divided into 4 groups. Two seed germinating papers cover the bottom of a plastic tray. One group (50 seeds/group) of seeds is dispersed onto the germinating paper then the seeds are covered by another germinating paper, and both of the germinating papers are wetted. The plastic tray is covered and stored in a location without illumination. During the test, the seeds are checked every day. Seeds that succumb to mildew are removed and the germinating paper is rewetted. The number of germinating seeds is counted on the fourth and seventh day. The germination rate is the average of the four groups of the tested seeds.

Flowability: 25 g of coated seeds are introduced into a 3 cm internal diameter glass tube and sealed by a cap. The direction of this tube is then inverted. Acceptable flowability means all of the coated seeds will flow down in 1 second while unacceptable flowability means all or parts of the coated seeds will stay on the top of the glass tube for over 2 seconds.

Molecular Weight: The weight average molecular weight (Mw) of the polydimethylsiloxane is measured according to “Gel Permeation Chromatography” (“GPC”) that is performed on a VISCOTEK™ GPC Max using a triple detection capability. The VISCOTEK™ TDA305 unit is equipped with a differential refractometer, an online differential pressure viscometer, and low angle light scattering (LALS: 7° and 90° angles of detection). The mobile phase is high performance liquid chromatography grade Toluene. The columns are two PL Gel Mixed C from Varian—(7.5*300 mm, 5μιη particle size) and a PL Gel Guard column from Varian—(7.5*300 mm) 5 fractom Injection volume with a flow of 1 mL/min and a run time of 37 min. The column and detector temperature are 40° C. The software used is Omnisec 4.6.1 from VISCOTEK™. The detectors are calibrated by injection of a narrow polystyrene standard (Mw 68,100 g/mol) of a known concentration. Correct run parameters are checked by using a narrow molecular weight distribution polystyrene standard (PS71K). The molecular weight averages must be within the Statistical Process Control (SPC) chart in order to validate the detectors calibration. Typical GPC3 precision and accuracy (which depends on the refractive index increment) are around 2-3%.

### Materials

Coalescent is 2,2,4-Trimethyl-1,3-pentanediol monoisobutyrate and is commercially available as Texanol™ coalescent from The Eastman Chemical Company, Kingsport, Tennessee.

PDMS is a water emulsion of polydimethylsiloxane having a weight average molecular weight of 569,000 g/mol and having an 80 wt % solids content. The PDMS is available from The Dow Chemical Company, Midland, Michigan.

Seed: The seeds that were coated by the seed coating composition were Zhengdan 958 maize hybrid seeds commercially available from the Food and Crop Research Institute, Henan Academy Agricultural Sciences.

Silane-functionalized polymer (“SSA”): The SSA is prepared according to the following instructions. Form a monomer emulsion (ME1) from 670 grams (g) of deionized water, 22.5 g fatty alcohol polyglycol ether sulphate sodium salt emulsifier (commercially available as DISPONIL™ FES 993 emulsifier (“FES 993”)), 825 g butyl acrylate (“BA”), 345 g methyl methacrylate (“MMA”), 300 g styrene (“ST”), 30 g glacial methacrylic acid (“MAA”) and 21.70 g of vinyltrimethylsiloxane. 750 g of and 5.77 g of FES are added to a 5-liter 4-neck flask equipped with a mechanical stirrer, a reflux condenser, a thermocouple, and inlets for monomer emulsion and initiator solution. The contents of the flask are stirred and heated to 82° C. A seed charge of 76.3 g of ME1 is added to the flask followed by an initiator solution consisting of 10 g of deionized water and 3.75 g of sodium persulfate. The seed charge and the initiator solution are rinsed to the flask with deionized water. Polymerization of the seed charge is monitored by a thermocouple and when the temperature of the reaction mixture has peaked, the remainder of ME1 as well as a second initiator solution consisting of 200 g of deionized water, 0.75 g of sodium persulfate, and 10.5 g of sodium carbonate is fed into the reactor monotonically over 150 minutes, while the reactor temperature is controlled at 85° C. After completion of the feeds, the ME1 and initiator solution are rinsed into the flask using deionized water and the reactor is held at 85° C. for 10 minutes. The reactor is cooled to 80° C., then a solution of 0.02 g of ferrous sulfate heptahydrate and 0.02 g of ethylenediaminetetraacetic acid tetrasodium salt in 5 g of deionized water is added to the flask and rinsed with deionized water. Residual monomer in the reaction mixture is polymerized by feeding a solution of 4 g of z-butyl hydroperoxide in 20 g of deionized water. Next a solution of 2.2. g of isoascorbic acid in 20 g of deionized water is added to the flask over 20 minutes while cooling the reaction mixture to 55° C. After the feeds are complete, the reaction mixture is cooled to 30° C. and neutralized to a pH of 8 using ammonium hydroxide solution. Once neutralized, a solution consisting of 0.36 g of KATHON™ LX 1400 Preservative, 21.73 g of FES, and 8.19 g of deionized water is added to the flask. The resulting latex is filtered to remove coagulum. The measured solids of the resulting latex is 46.0%. The SSA has a glass transition temperature of 0° C. to 40° C. as measured according to ASTM D7028.

Active Ingredient Dispersion: The active ingredient dispersion (“AID”) is formed from the materials of Table 1.

TABLE 1

| | Weight | Commercially | | |
|---|---|---|---|---|
| Material | (g) | available as | Supplier | Use |
| Thiamethoxam | 30.72 | | Hebei Handan | Active |
| (97.65 wt % purity) | | | Ruitian Pesticide | ingredient |
| | | | Co., Ltd. | |
| Ethylene oxide and | 15 | DOWFAX ™ | The Dow Chemical | Dispersing |
| propylene oxide | | D-800 | Company | agent |
| copolymer emulsion, | | | | |
| 20 wt % solids in | | | | |
| water | | | | |
| Polyacrylate dispersant, | 1 | POWERBLOX ™ | The Dow Chemical | Dispersing |
| 20 wt % solids in water | | D-305 | Company | agent |
| Alcohol alkoxylate | 1 | TERGITOL ™ | The Dow Chemical | Wetting agent |
| | | W-600 | Company | |
| Propylene glycol | 3 | | Sinopharm | Anti-freeze |
| | | | | agent |
| Polydimethylsiloxane, | 0.3 | XIAMETER ™ | The Dow Chemical | Anti-foam |
| 20% actives in water | | AFE-0020 | Company | agent |
| Magnesium | 1 | | | Thickening |
| aluminometasilicate | | | | agent |
| Xanthan gum | 8 | | | Thickening |
| (2 wt % in water) | | | | agent |
| Water | 19.98 | | | |
| Pigment | 5 | DYCOSEED ™ | Dychrom | Color paste |
| | | Red R2002-S | Technology | |

The AID is formed by combining the water, propylene glycol, TERGITOL™ wetting agent, the DOWFAX™ dispersing agent and the POWERBLOX™ dispersing agent into a stainless-steel jar of a Geruisi SMJ-2-180 sand miller, and mixing them together until completely dissolved. then the XIAMETER™ anti-foaming agent is added to form a solution. Thiamethoxam and magnesium aluminometasilicate are added into the solution and is first mixed with a glass rod, then mixed with an IKA T25 digital high-speed homogenizer at 4,000 rpm for 5 minutes to form a uniform slurry. Then, 72 g grinding beadings (Φ=0.8-1.0 mm) are added into the slurry. The slurry is ground for 4 hours. After grinding, the pesticide formulation is filtered with a 100 mesh strainer to remove beadings and large thiamethoxam particles to obtain the initial formulation. Color paste and xanthan gum are added to the formulation and mixed with the high speed homogenizer at 4,000 rpm for 15 minutes to form the AID.

### Sample Preparation

Comparative example (“CE”) 1 is an uncoated seed. CE2-5 and inventive examples (“IE”) 1-4 are prepared by combining the AID, water, 0.4 wt % Coalescent, the silane-functionalized polymer emulsion and the PDMS emulsion in the indicated amounts to form the seed coating composition and then applying the examples to seeds. One gram of the seed coating composition is added to a 200 milliliter (“m1”) plastic bottle along with 50 g of corn seed. The plastic bottle is immediately capped. Next the plastic bottle is shaken by hand with a frequency of two times per second for 1 minute to guarantee all of the corn seeds are coated by the seed coating composition. After shaking, the corn seeds are poured onto a release paper and dried overnight.

### Results

Table 2 provides the composition of IE1-4 and CE1-5 as well as the measured values for the different tests performed. The weight percents provided in Table 2 for the SSA and the PDMS indicate the weight of the emulsion added based on the total weight of the seed coating composition. “NM” in Table 2 represents that a value was not measured.

TABLE 2

| | | | | | Solid weight | Attrition | Germination | | |
|---|---|---|---|---|---|---|---|---|---|
| | AID | SSA | PDMS | Water | ratio of SSA to | Rate | rate | Water | |
| Example | (wt %) | (wt %) | (wt %) | (wt %) | PDMS | (%) | (%) | Resistance | Flowability |
| CE1 | 0.00 | 0.00 | 0.00 | 0.00 | 0 | | 99 | NM | Good |
| CE2 | 85.00 | 10.87 | 0.00 | 3.73 | N/A | 0.26 | 90 | Good | Good |
| CE3 | 85.00 | 10.65 | 0.13 | 3.82 | 98:2 | 0.2 | NM | Good | Good |
| CE4 | 85.00 | 10.43 | 0.25 | 3.92 | 96:4 | 0.19 | NM | Good | Good |
| IE1 | 85.00 | 10.22 | 0.38 | 4.01 | 94:6 | 0.1 | 99 | Good | Good |
| IE2 | 85.00 | 10.00 | 0.50 | 4.10 | 92:8 | 0.07 | NM | Good | Good |
| IE3 | 85.00 | 9.78 | 0.63 | 4.19 | 90:10 | 0.07 | 90 | Good | Good |
| IE4 | 85.00 | 9.24 | 0.94 | 4.42 | 85:15 | 0.04 | NM | Good | Good |
| CE5 | 85.00 | 8.70 | 1.25 | 4.65 | 80:20 | 0.04 | 70 | Good | Good |

As can be seen from Table 2, increased dosage of PDMS into the seed coating composition lowers the attrition rate. For example, IE1-IE4 which include from 0.38 wt % to 0.94 wt % PDMS emulsion dramatically decrease the attrition rate as compared to CE2-CE4. With respect to CE5, it can be seen that the addition of too much PDMS negatively impacts seed germination. IE2 demonstrates that the use of the silane-functionalized polymer in conjunction with PDMS does not negatively impact the water resistance of the seed coating composition or the flowability of the coated seeds. As such, the seed coating composition allows for an attrition rate less than 8%, meets water resistance and flowability properties while achieving an 85% seed germination rate or better.

What is claimed is:

1. A seed coating composition, comprising
a silane-functionalized polymer, wherein the silane-functionalized polymer is acrylate-based; and
polydimethylsiloxane having a weight average molecular weight of 500,000 g/mol or greater as measured according to Gel Permeation Chromatography.

2. The seed coating composition of claim 1, wherein the silane-functionalized polymer comprises units derived from a silane monomer selected from the group consisting of vinyltrimethoxysilane, methacryloxy propyl trimethoxyl silane and combinations thereof.

3. The seed coating composition of claim 2, wherein the silane-functionalized polymer comprises units derived from butyl acrylate, methyl methacrylate, glacial methacrylic acid and styrene.

4. The seed coating composition of claim 1, wherein the polydimethylsiloxane has a weight average molecular weight of 500,000 g/mol to 2,500,000 g/mol as measured according to Gel Permeation Chromatography.

5. The seed coating composition of claim 1, wherein the silane-functionalized polymer has a glass transition temperature of 0° C. to 40° C. as measured according to ASTM D7028.

6. The seed coating composition of claim 1, wherein a weight ratio of the silane-functionalized polymer to the polydimethylsiloxane within the seed coating composition is from 99:1 to 75:25.

7. The seed coating composition of claim 6, wherein the weight ratio of the silane-functionalized polymer to the polydimethylsiloxane within the seed coating composition is from 96:4 to 85:15.

8. The seed coating composition of claim 1, further comprising:
water, wherein the silane-functionalized polymer, the polydimethylsiloxane and the water form an emulsion.

9. A coated seed, comprising:
a seed defining an exterior surface; and
the seed coating composition of claim 1 in contact with the exterior surface of the seed.

10. A method of forming a coated seed, comprising the steps:
forming a silane-functionalized polymer that is acrylate-based;
combining a polydimethylsiloxane having a weight average molecular weight of 500,000 g/mol or greater as measured to Gel Permeation Chromatography with the silane-functionalized polymer to form a seed coating composition; and
applying the seed coating composition to a seed to form a coated seed.
